(19) United States
(12) Patent Application Publication
(10) Pub. No.: US 2013/0002574 A1
(43) Pub. Date: Jan. 3, 2013

(54) APPARATUS AND METHOD FOR EXECUTING APPLICATION IN PORTABLE TERMINAL HAVING TOUCH SCREEN

(75) Inventors: Ki-Yeung KIM, Gyeonggi-do (KR); Jong-Min LEE, Incheon (KR); Gi-Tae MUN, Gyeonggi-do (KR)

(73) Assignee: SAMSUNG ELECTRONICS CO., LTD., Gyeonggi-Do (KR)

(21) Appl. No.: 13/440,399

(22) Filed: Apr. 5, 2012

(30) Foreign Application Priority Data
Jun. 30, 2011 (KR) 10-2011-0064567

(51) Int. Cl. G06F 3/041

(52) U.S. Cl. 345/173

(57) ABSTRACT

An apparatus and method for defining objects representing respective applications, verifying an object used as an input tool by a user through an input size and an input shape which are input on a touch screen, and executing an application defined by the verified object. The apparatus preferably includes an object analyzing unit for verifying a touch input size and identifying a type of an object input on the touch screen and a controller for executing an associated application that corresponds to or is linked with the identified object.

### CLAIM OF PRIORITY

This application claims the benefit of priority under 35 U.S.C. §119(a) from a Korean patent application filed in the Korean Intellectual Property Office on Jun. 30, 2011 and assigned Serial No. 10-2011-0064567, the entire disclosure of which is hereby incorporated by reference in its entirety.

### BACKGROUND OF THE INVENTION

1. Field of the Invention

The present invention relates to an apparatus and method for executing an application in a portable terminal More particularly, the present invention relates to an apparatus and method for defining objects representing respective applications, and executing an application defined by a verified object.

2. Description of the Related Art

Portable terminals have become necessities of modern life for people of all ages. Thus, service providers and terminal manufacturers are competitively developing differentiated products (or services) that extend far beyond simple voice communication.

For example, the portable terminal has developed into a multimedia device capable of providing various functions such as a phonebook function, a game function, a short message function, an e-mail function, a wake-up call function, an MPEG-1 Audio Layer 3 (MP3) function, a scheduling function, a digital camera function, a multimedia message function, and a wireless Internet function, just to name a few of the various functions.

The above-described functions are connected with a menu interface for accessing and activating such functions. The menu interface includes a plurality of application items.

A conventional portable terminal outputs a plurality of menu items on a main picture. Each of the output menu items may include a plurality of application items.

In that, a user of the portable terminal selects a menu item, selects an application included in the menu item, and executes the selected application. The user must recognize that menu items include respective applications. For a user not versed with the menu items or one who rarely uses certain ones, there is difficulty in finding a particular application as it is more guess work to pick the correct menu item having the particular application.

If the user selects a menu item incorrectly, he or she must perform a process of reselecting another menu item and searching the menu item including the desired application for execution.

There is a problem in that the portable terminal provides a menu of a tree structure, making it even more difficult to select and execute an application. Accordingly, there is a need in the art for an improved method of executing an application in a portable terminal is needed.

### SUMMARY OF THE INVENTION

An exemplary aspect of the present invention is to—provide an apparatus and method for simplifying an application selection and execution process of a portable terminal

Another exemplary aspect of the present invention is to provide an apparatus and method for classifying an application executed per object in a portable terminal

Still another exemplary aspect of the present invention is to provide an apparatus and method for having an object according to a characteristic of an application and executing the corresponding application through touch input using the object.

Yet another exemplary aspect of the present invention is to provide an apparatus and method for differently defining a contact surface or capacitance of an object to providing a characteristic to an object in a portable terminal

In accordance with an exemplary aspect of the present invention, an apparatus for executing an application in a portable terminal having a touch screen is provided. The apparatus preferably includes an object analyzing unit for verifying a touch input size and ascertaining a kind (i.e. type) of an object input on the touch screen and a controller for executing an application corresponding to the ascertained object.

In accordance with another exemplary aspect of the present invention, a method of executing an application in a portable terminal having a touch screen is provided. The method preferably includes verifying a touch input size and ascertaining a kind (i.e. type) of an object input on the touch screen and executing an application corresponding to the ascertained object.

In accordance with still another exemplary aspect of the present invention, an apparatus for executing an application in a portable terminal having a touch screen is provided. The apparatus preferably includes an object input unit for being in contact with an object having contact surfaces of different shapes and capacitance, an object analyzing unit for ascertaining the object contacted to the object input unit and an application corresponding to the object, a non-transitory memory for storing information of the application, which is standard of object ascertainment, and information of applications executed according to objects, a display unit for outputting execution information of the application corresponding to the object, and a controller which includes a processor or microprocessor for executing the application ascertained by the object analyzing unit.

### BRIEF DESCRIPTION OF THE DRAWINGS

The above and other exemplary aspects, characteristics and advantages of certain exemplary embodiments of the present invention will become more apparent to a person of ordinary skill in the art from the following detailed description taken in conjunction with the accompanying drawings, in which:

FIG. 1 is a block diagram illustrating a structure of a portable terminal capable of executing an application using an object according to an exemplary embodiment of the present invention;

FIG. 2 is a flowchart illustrating a process of executing an application in a portable terminal according to an exemplary embodiment of the present invention;

FIG. 3 is a flowchart illustrating a process of providing object information in a portable terminal according to one exemplary embodiment of the present invention;

FIG. 4 is a table illustrating information of an application corresponding to an object according to one exemplary embodiment of the present invention; and

FIG. 5 illustrates a picture for executing a Korean chess application in a portable terminal according to one exemplary embodiment of the present invention.

### DETAILED DESCRIPTION

Exemplary embodiments of the present invention will now be described herein below with reference to the accompanying drawings. In the following description, well-known functions or constructions may not described in detail when their inclusion would obscure the appreciation of the claimed invention by a person of ordinary skill in the art with unnecessary detail of such well-known functions and constructions.

Hereinafter, an apparatus and method for simplifying an application execution process to have an object according to a characteristic of an application and execute the corresponding application through touch input using the object will be described infra.

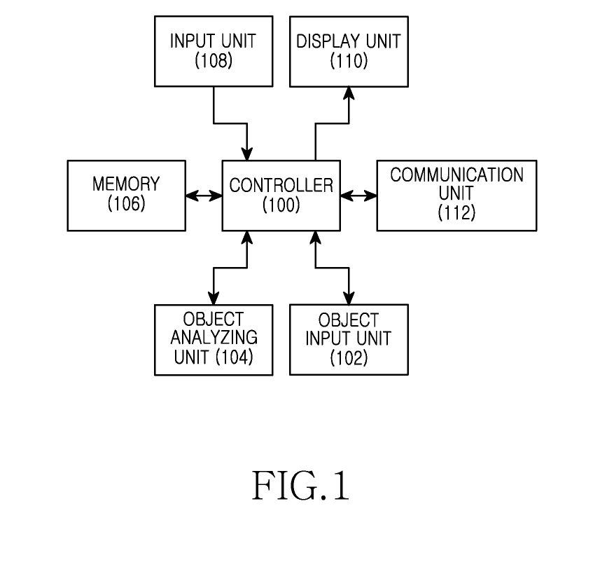

FIG. 1 is a block diagram illustrating a structure of a portable terminal capable of executing an application using an object according an exemplary embodiment of the present invention.

Referring now to FIG. 1, the portable terminal preferably includes a controller 100, an object input unit 102, an object analyzing unit 104, a memory 106, an input unit 108, a display unit 110, and a communication unit 112.

The object input unit 102 and the object analyzing unit 104 may be configured as one or more another controller.

The controller 100, which comprises a processor or microprocessor, controls an overall operation of the portable terminal. For example, the controller 100 processes and controls voice communication and data communication. In addition to control of general functions, the controller 100 verifies that contact area of the object input unit corresponds to a surface of an input object, determines the particular object which is displayed on a touch screen, and executes an application corresponding to the determined object.

In addition, the controller 100 ascertains a movement path and information (e.g., an object name, a movement order, etc.) of the object which is put on the touch screen and provides an output of the ascertained information to a user.

The method described hereunder of the present invention may be provided as one or more instructions in one or more software modules stored in the memory 106. The software modules may be executed by the controller 100.

The object input unit 102 receives information regarding a plurality of objects with different types of contact surfaces. The object input unit 102 may be included in the input unit 108. In fact, it is within the spirit and scope of the presently claimed invention that the object input unit, input unit and display unit could all be served by a single touch screen. In addition, the object input unit 102 has a minimum size capable of receiving information of an object according to one exemplary embodiment of the present invention. The object input unit 102 can help to execute an application corresponding to the object. This structure results in a size of the input unit 108 being reduced according to a minimizing trend of the portable terminal.

In one embodiment of the present invention, the object input unit 102 is included in a touch screen according. The object input unit 102 can assist in execution of an application or the operation control of the application. Herein, the operation control of the application may be operation maintenance of the application which is previously executed using the object. Also, the operation control of the application may be control of an application which is executed using an object selected by the user based on the previously executed application.

The object analyzing unit 104 ascertains (i.e. identifies) the object input to the object input unit 102. In that, the object analyzing unit 104 determines a type of the object which is arranged on the touch screen. The object analyzing unit 104 may analyze a contact surface of the object contacted detected by the object input unit 102 and output to the controller 100. One possible way the object analyzing unit may analyze the contact surface of the object is based on a sensed capacitance value of the object on the touch screen and determine the type of object by checking a list of values associated with respective objects. Herein, the object analyzing unit 104 stores contact surface information and capacitance information corresponding to respective objects, compares the size and the capacitance of the object contacted to the object input unit 102 with the stored information, and then can ascertain the kind of the object in contact with the touch screen.

The memory 106 includes a Read Only Memory (ROM), a Random Access Memory (RAM), and a flash ROM. The ROM stores a microcode of a program, by which the controller 100 and the object analyzing unit 104 are processed and controlled, and a variety of reference data.

The memory 106 utilizes RAM as a working memory of the controller 100 and stores temporary data that is generated while a variety of programs are being performed. Also, the memory includes flash ROM for storing a variety of rewritable data, such as phonebooks, outgoing messages, and incoming messages. The memory 106 stores information of an application corresponding to the object according to one embodiment of the present invention. Herein, the information of the application corresponding to the object includes contact surface information and capacitance information which correspond to the object.

The input unit 108 preferably includes alphanumeric key buttons including of ‘0’ to ‘9’ and a plurality of function keys such as a menu button, a cancel button, an OK button, a talk button, an end button, an Internet access button, a navigation key (or directional key) button, and a character input keys. The input unit 108 provides a key input data corresponding to a key pushed by the user to the controller 100. In addition, the input unit 108 senses input of the user, which controls an application executed through the object input to the object input unit.

The display unit 110 is configured to displays status information which is generated while the portable terminal is operated, characters, large volumes of moving and still pictures, etc. The display unit 110 may be a color Liquid Crystal Display (LCD), an Active Matrix Organic Light Emitting Diode (AMOLED), etc. The display unit 110 preferably doubles as a touch input device. When the display unit 110 is applied to a touch input type portable terminal, it may be used as an input device. In addition, the display unit 110 outputs an operation for an application corresponding to object input according to the present invention. Again, the types of portable terminals of the presently claimed invention includes a wide variety of devices, virtually any electronic device with a display that can operate will the user is in motion or changing locations.

A touch sensitive display, called as a touch screen, may be used as the display unit 110. In this situation, touch input may be performed via the touch sensitive display.

The communication unit 112 transmits and receives a Radio Frequency (RF) signal of a data which is input and output through an antenna (not shown). For example, in a transmitting process, a data to be transmitted can be transmitted by virtually any known protocol and is not restricted to any particular type of protocol. One possible way of the plurality of very different ways of wireless transmission compatible with the presently claimed invention may include a spread spectrum technology, which is subject to a channel-coding process and a spreading process, and then the data is transformed to an RF signal. In a receiving process, the RF signal is received and transformed to a baseband signal, and the base-band signal is subject to a de-spreading process and a channel-decoding process, thereby restoring the data.

The function of the object analyzing unit 104 may be performed by the controller 100 of the portable terminal However, the present invention includes the controller 100 and the object analyzing unit 104 which are exemplary configurations for the convenience of explanation and are not limited to a scope of the prevent invention. It will be understood by those skilled in the art that various changes in form and details may be made therein without departing from the spirit and scope of the present invention. For example, the object analyzing unit and object input unit may include their own respective processor or microprocessor and communicate with the controller 100, or the claimed invention can also be practiced such that the aforementioned functions of some or all of the units can be processed in the controller 100.

According to the present invention, for example, an electronic device comprising one or more controller, a touch screen, a memory and one or software modules stored in the memory configured for execution by the controller, the software modules comprising one or more instruction to verify a touch input size and identify a type of object arranged on the touch screen, and execute an application corresponding to the identified object.

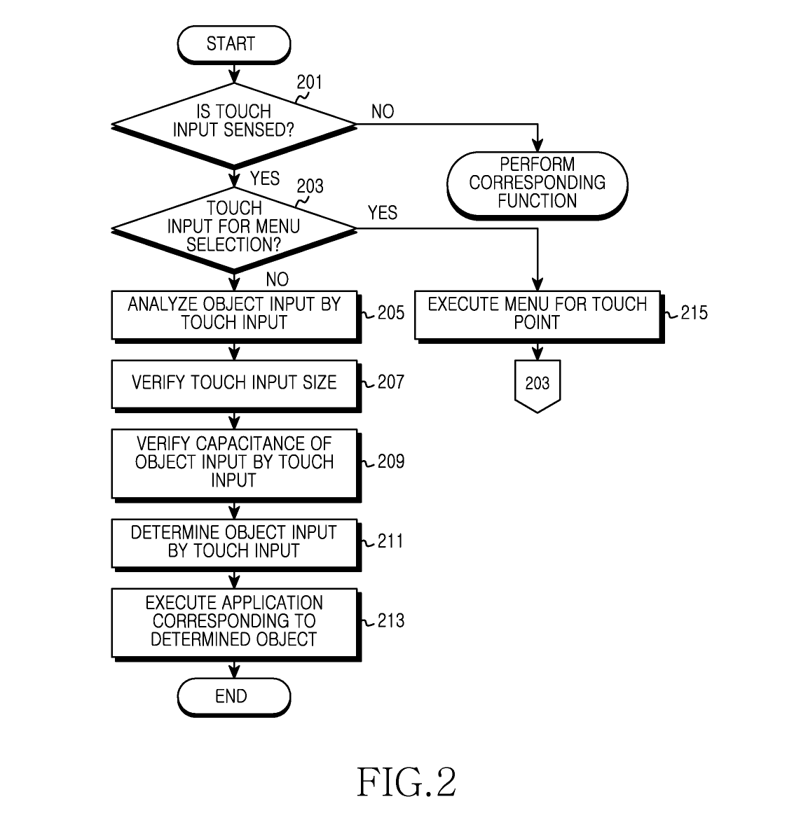

FIG. 2 is a flowchart illustrating an exemplary operational process of executing an application in a portable terminal according to the present invention.

Referring now to FIG. 2, at step 201, the portable terminal verifies whether touch input of a user is sensed.

When at step 201 it is verified that the touch input is not sensed in step 201, the portable terminal performs a corresponding function (e.g., a waiting mode).

However, when at step 201 it is verified that the touch input is sensed, the process proceeds to step 203 and the portable terminal verifies whether touch input for menu selection is sensed. Herein, for this exemplary embodiment the touch input for menu selection refers to the general touch input unit that allows the user to cause the portable terminal to perform actions in response to touching a touch screen with a stylus, pen, or his or her finger.

When at step 203 it is verified that the touch input for menu selection is sensed, the operation proceeds to step 215 and executes a menu corresponding to a point on which the touch input is generated.

When it is verified at step 203 that the touch input is not a touch for menu selection, it is then verified at step 205 that a touch input using an object having a contact surface of a different type than a type used for menu selection is generated, and the portable terminal proceeds performs a process of analyzing an object input on a touch screen of the portable terminal The contact surface of the different type than the type used for menu selection may also be different from a predetermined type.

As described above, each of objects used for selection according to the present invention has a different contact surface. According to the present invention, the portable terminal may execute a particular application that corresponds to a particular contact surface. In addition to the contact surface, the portable terminal compares capacitance of an object input on the touch screen by a user with stored capacitance information of a plurality of objects and may ascertain a kind of an application to be executed.

As described above, the portable terminal for analyzing the object input on the touch screen verifies a touch input size of the object in step 207. The portable terminal verifies capacitance of the object input by the touch input in step 209. Herein, the touch input size may include an input shape of the object contacted with the touch screen. Thus, in the presently claimed invention, the touch input size and the capacitance sensed by touch screen when there is contact can be used in conjunction or separately as a basis to ascertain the type of object used for contact with the touch screen. The artisan also appreciates that other types of functional touch screen use resistance, infrared, i.e., surface acoustic wave (SAW),

The process then proceeds to step 211 and the controller of the portable terminal determines the object input on the touch screen. For example, the portable terminal stores object information corresponding to the touch input size in advance and may determine whether the object corresponding to the touch input is a chessman or a Korean chessman.

The process then proceeds to step 213 and the controller of the portable terminal executes an application corresponding to the object determined in step 211. In that, when it is verified that the object input on the touch screen is the Korean chessman, the portable terminal executes a Korean chess application. In addition, if the object is a coin, a corresponding application that involves money (for example, Quicken® or a banking application) could be activated, or so could a casino game that involves wagering.

Thereafter the execution of the chess application, the portable terminal ends the algorithm of FIG. 2. It is within the spirit and scope of the claimed invention that a confirmation screen could be displayed, or the application can be automatically executed. According to the present invention, a changeable default can be provided regarding automatic execution or confirmation. Also, a cancel operation prompt could be temporarily displayed as well. The method performed according to FIG. 2 may be provided as one or more instructions in one or more software modules stored in the storage unit. In that case, the software modules may be executed by the controller 100.

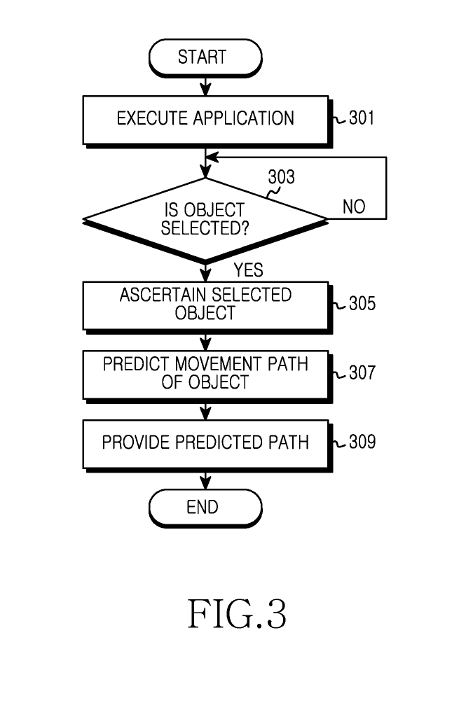

FIG. 3 is a flowchart illustrating an exemplary process of providing object information in a portable terminal according to another exemplary embodiment of the present invention.

Referring now to FIG. 3, at step 301 the portable terminal executes an application. Herein, the portable terminal may be in a state where the application corresponding to an object input on a touch screen is executed.

The method proceeds to step 303 and the controller of the portable terminal verifies whether an object has been selected. Herein, the selection of the object refers to the selection of an object which is positioned on the touch screen or an icon of an object output on the touch screen. The sensing of the selection of the object may be performed sensing the provision of pressure on the object which is positioned on the touch screen or the icon and sensing release of a touch input of the object. In addition to the method, the portable terminal can classifies inputs of a user, and is capable of classifying objects, and may determine selection of the type of object based on what is sensed by sensors communicating with the input object unit.

If it is verified that the object is not selected in step 303, the portable terminal re-performs step 303 repeatedly.

On the other hand, if the controller determines at step 303 that the object has been selected, the method proceeds to step 305 and the portable terminal identifies the selected object. Herein, the portable terminal performs operations of step 207 to step 211 and ascertain the selected object.

With continued reference to FIG. 3, the method proceeds to 307 and the portable terminal predicts a movement path of the ascertained object. In other words, the portable terminal ascertains characteristics of the selected object. For example, the ascertained characteristics may comprise a movable position of a selected Korean chessman or chessman, an instrument play order corresponding to previously selected music, etc.

Next, the method proceeds to step 309 and the portable terminal provides the path predicted in step 307 to the user. For example, the portable terminal may display positions where a corresponding object may move on a Korean chessboard or a chessboard.

Thereafter, the portable terminal ends the algorithm of FIG. 3.

The method performed according to FIG. 3 may be provided as one or more instructions in one or more software modules stored in the storage unit. In that case, the software modules may be executed by the controller 100.

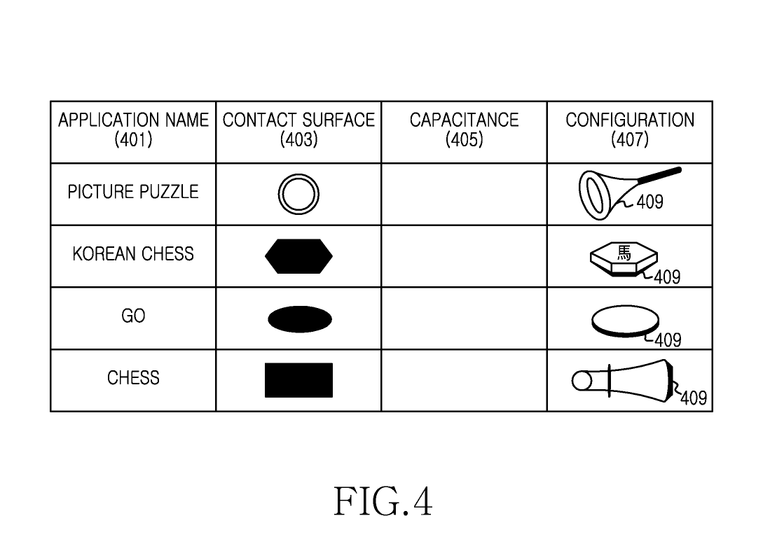

FIG. 4 is a table illustrating information of an application corresponding to an object according to one exemplary embodiment of the present invention.

Referring now to FIG. 4, a portable terminal may execute an application by touch input for a contact surface of a specific shape.

The above-described portable terminal preferably stores application information corresponding to a contact surface of a touch screen to execute an application. The application information corresponding to the contact surface includes an application name 401, a contact surface 403, and capacitance 405. The corresponding relationship can be a default that is changeable or editable by the user or an update from a network or peer to include other items.

The application name 401 is information about an application to be executed when an object corresponding to the contact surface 403 is input on a touch screen. The contact surface 403 typically refers to a size or a shape input on the touch screen when respective objects are input.

Also, the capacitance 405 is information analyzed for determining touch input for executing the application. The portable terminal compares the contact surface 403 and the capacitance 405 and may verify information of an application to be executed. The capacitance 405 may be provided as numeric values by experiments, for example, in divisions of farads or in numeric relative values of capacitance, just to name two of the many possibilities within the scope of the claimed invention. Writing of numeric values is omitted in FIG. 4. Again, depending upon the type of touch screen, equivalent characteristics other than capacitance may be used by resistive or SAW screens.

For another example of the many possibilities within the scope of the presently claimed invention, a user of the portable terminal performs touch input with a trumpet-shaped touch pen. The portable terminal verifies a contact surface and capacitance sensed by the touch input of the touch pen and may determine that a picture puzzle application must be executed.

In addition, the portable terminal verifies square-shaped touch input and capacitance and may determine that a chess application must be executed.

As shown in FIG. 4, an object 409 corresponding to the picture puzzle application may include a trumpet-shaped touch pen. An object 409 corresponding to a Korean chess application may include a Korean chessman having a hexagonal contact surface. Also, an object 409 corresponding to a “go” application may include a go piece having a circular contact surface. An object 409 corresponding to the chess application may include a chessman having a square-shaped contact surface.

In addition, the portable terminal may come with, or can be sold separately, a plurality of tokens of various sizes and shapes, capacitances, etc. Such tokens can be attached on a ring as an accessory and the user can identify applications on the portable terminal to be executed according to respectively associated tokens.

An exemplary configuration 407 shown in FIG. 4 implements objects corresponding to contact surfaces 403 as one exemplary embodiment of the present invention.

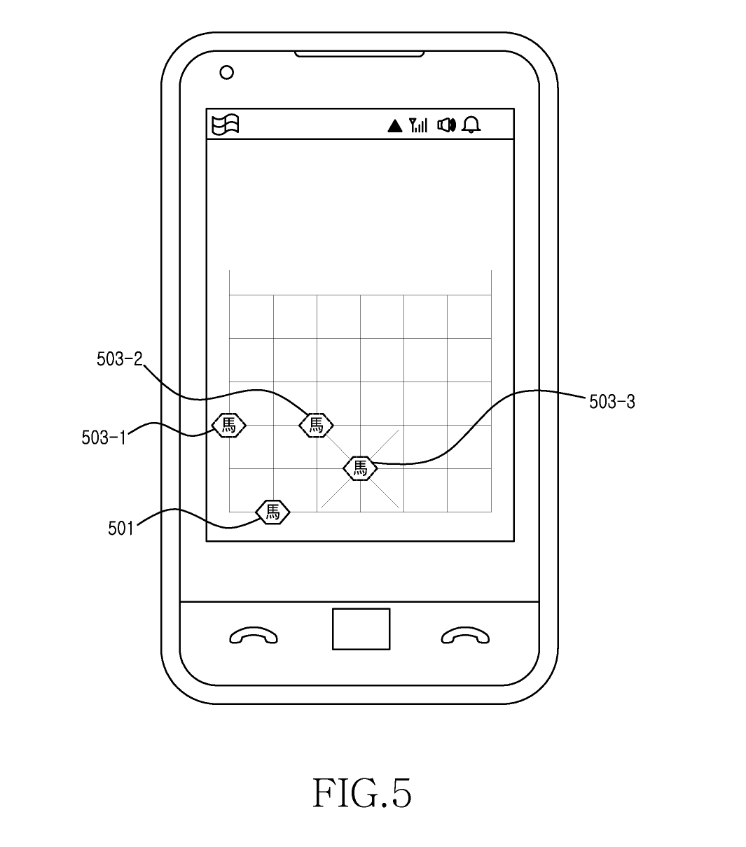

FIG. 5 illustrates a picture for executing a Korean chess application in a portable terminal according to another exemplary embodiment of the present invention.

Referring now to FIG. 5, the portable terminal detects that a user has placed an object corresponding to a Korean chessman on a touch screen in a state where a waiting picture is displayed or a specific application is executed. The above-described portable terminal may be a board game terminal for supporting a plurality of board games. The portable terminal includes objects (e.g., a go piece, a Korean chessman, a chessman, a block, a dice, etc.) corresponding to respective board games. For this reason, the user of the portable terminal may execute a specific application through an operation in which he or she puts an object simply on the touch screen of the portable terminal

In other words, the sensing by the portable terminal of an action of the user who puts an object corresponding to the Korean chessman on the touch screen refers to an action indicating that the portable terminal can sense the user wants the portable terminal to execute a Korean chess application from among a plurality of board games.

Therefore, in an exemplary embodiment of the present invention, the portable terminal analyzes a size and capacitance of an object which is put on the touch screen by the user and may identify that the object arranged on or substantially on the screen corresponds to a Korean chessman. An artisan appreciates that depending on the type of touch screen, certain objects may come within a predetermined distance of the touch screen and can be sensed without necessarily making physical contact with the screen (i.e. “substantially on”). The predetermined distance would depend on the capabilities and characteristics of the screen and the object.

Therefore, as shown in FIG. 5, the portable terminal executes a Korean chess application and outputs a Korean chessboard and Korean chessmen.

The user of the portable terminal may control an operation of an application executed through object selection or object motion. In that, the portable terminal can sense that the position of an object corresponding to a Korean chessman on the touch screen has changed and continuously executes the Korean chess application. Also, the portable terminal can provide a Korean chess icon output on the touch screen, changes a position of the selected icon, and may execute the Korean chess application continuously.

In addition, the portable terminal may ascertain a movement path for each Korean chessman (object or icon). Therefore, when the portable terminal detects that a user selects a Korean chessman, the portable terminal provides a guideline for the movement path of the selected Korean chessman.

In that, as shown in FIG. 5, when it is verified that a Korean chessman corresponding to a reference number 501 is selected, the portable terminal may provide information about positions where the Korean chessman may be moved like reference numbers 503-1, 503-2, and 503-3, for example, within the rules of the game.

The result of the present invention is that the portable terminal itself provides the guideline such that a user who does not recognize or know how to utilize a corresponding application can easily be taught to use the corresponding application.

In addition, the portable terminal may be a terminal that permits playing of a musical instrument in electronic form. The user of the portable terminal selects music and a musical instrument he or she wants to play and may start a performance.

Therefore, in response to detected user selection, the portable terminal loads a score of the selected music and may provide a performance order of the selected musical instrument. For example, when the user of the portable terminal selects and plays a keyboard, the portable terminal ascertains an order and time of the keyboard pushed by the user and provides the ascertained information to the user with reference to the loaded score.

For this reason, the user of the portable terminal sequentially pushes the keyboard on the touch screen using the order and time of the keyboard provided by the portable terminal and plays a corresponding music.

As described above in the examples provided merely for illustrative purposes, the present invention simplifies an application execution process. The present invention has an object associated with a characteristic of an application and executes the corresponding application through touch input using the object to solve a problem in that a user directly enters a menu item and executes an application like a conventional portable terminal.

The above-described methods according to the present invention can be implemented in hardware or as software or computer code that can be stored in a recording medium such as a thumbnail drive, CD ROM, RAM, a floppy disk, a hard disk, or a magneto-optical disk or other type of non-transitory storage downloaded over a network and stored on a non-transitory machine readable medium, so that the methods described herein can be rendered in such software using a general purpose computer that becomes a special purpose computer, or a special processor or microprocessor in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

While the present invention has been particularly shown and described with reference to exemplary embodiments thereof, it will be understood by those skilled in the art that various changes in form and details may be made therein without departing from the spirit and scope of the present invention as defined by the appended claims. For example, the presently claimed invention can also be practiced with a camera function in which stored images of objects are associated with applications. For example, one could hold the Korean chessman in front of the camera unit (not shown) and the camera can capture the image and identify same with images in storage and execute a corresponding application that is linked with certain images, for example, through the use of a table in storage.

What is claimed is:

1. An apparatus for executing an application in a portable terminal having a touch screen, the apparatus comprising:
an object analyzing unit that analyzes at least one physical characteristic of an object to identify a type of an object sensed on the touch screen; and
a controller that executes an application that is associated with the identified object.

2. The apparatus according to claim 1, wherein the physical characteristic includes a size of a touch input.

3. The apparatus according to claim 1, wherein the physical characteristic includes a value of capacitance of the object sensed by the touch screen.

4. The apparatus of claim 1, wherein the object comprises one of a plurality of objects and each of the objects has contact surfaces with a respectively different shape.

5. The apparatus of claim 1, wherein the object analyzing unit verifies capacitance of the input object on the touch screen, compares the verified size and capacitance with information of the application corresponding to the object from storage, and identifies the type of the object.

6. The apparatus of claim 1, wherein the object analyzing unit analyzes a physical characteristic of a selected object after the application is executed, and wherein the controller provides the characteristic of the object, which is ascertained by the object analyzing unit.

7. The apparatus of claim 6, wherein the physical characteristic of the object includes at least one of a movement path of the object, a selection order of the object, and a name of the object.

8. The apparatus of claim 1, wherein the object comprises one of a plurality of tokens with distinguishing physical characteristics that are associated with an editable default of a plurality of respective applications.

9. The apparatus of claim 1, wherein the touchscreen comprises a resistive touchscreen.

10. The apparatus of claim 1, wherein the touchscreen comprises a surface acoustic wave (SAW) touchscreen.

11. The apparatus of claim 1, wherein the touchscreen comprises an object input unit separate from or on a designated area of the touchscreen.

12. The apparatus of claim 8, wherein the tokens are user-definable.

13. A method of executing an application in a portable terminal having a touch screen, the method comprising:
verifying by an object analyzing unit a touch input size and identifying a type of object arranged on the touch screen; and
executing by a controller an application corresponding to the identified object.

14. The method of claim 13, wherein the object comprises one of a plurality of objects and each object has a contact surface with a respectively distinguishable shape.

15. The method of claim 14, wherein the identifying of the type of object comprises:
verifying a sensed capacitance of the input object on the touch screen; and
comparing by the object analyzing unit the verified size and capacitance with information of the application corresponding to the object, which is previously stored.

16. The method of claim 14, further comprising identifying by the object analyzing unit a physical characteristic associated with a selected object after the application is executed and providing the physical characteristic of the object.

17. The method of claim 16, wherein the physical characteristic of the object includes at least one of a movement path of the object, a selection order of the object, and a name of the object.

18. A portable terminal for executing an application associated with an object input, the portable terminal comprising:
an object input unit for sensing contact with an object of a plurality of objects having at least one respective distinguishing physical characteristic;
an object analyzing unit for identifying the object in contact with a surface of the object input unit and a respective application corresponding to the identified object based on the at least one distinguishing physical characteristic;
a memory that stores information associated with the application, and information of applications respective executed according to objects associated therewith;
a display unit that outputs execution information of the respective application corresponding to the identified object; and
a controller that executes the application identified by the object analyzing unit.

19. The portable terminal according to claim 18, wherein the at least one respective distinguishing physical characteristic of the object comprises having contact surfaces with different shapes.

20. The portable terminal according to claim 18, wherein the at least one respective distinguishing physical characteristic of the object comprises having contact surfaces with different capacitances.
